(19) United States
(12) Patent Application Publication
(10) Pub. No.: US 2024/0378663 A1
(43) Pub. Date: Nov. 14, 2024

(54) VISUAL DISPLAY OF DATA FOR AUCTION

(71) Applicant: Regional Market Makers, Inc., Palo Alto, CA (US)

(72) Inventors: Pedro Javier Noyola de Garagorri, Palo Alto, CA (US); Alejandro Cortina Gallardo, Mexico City (MX); Fernando Molina Santos, Zempoala (MX)

(21) Appl. No.: 18/656,430

(22) Filed: May 6, 2024

Related U.S. Application Data
(60) Provisional application No. 63/464,853, filed on May 8, 2023.
(60) Provisional application No. 63/585,145, filed on Sep. 25, 2023.

(51) Int. Cl. G06Q 30/08; G06Q 30/04

(52) U.S. Cl. CPC G06Q 30/08; G06Q 30/04

(57) ABSTRACT

In preparation for receiving bids in an auction, an auction computer system generates a first score that represents a likelihood that a responsible party will default on an auctioned transaction and a second score that represents a likelihood of collection from the responsible party on a defaulted transaction. For each respective bidder of one or more bidders from the plurality of bidders, a display of a bidder computer system of the respective bidder displays a graph having a first axis corresponding to the likelihood that the responsible party will default on the transaction and a second axis corresponding to the likelihood of collection from the responsible party on a defaulted transaction, and display an indicia at a location in the graph correspond to the first score and the second score, and receive from at least one bidder of the one or more bidders a bid for the transaction.

### CROSS-REFERENCE TO RELATED APPLICATIONS

This application claims the benefit of priority to U.S. Application No. 63/464,853, filed on May 8, 2023, and the benefit of priority to U.S. Application No. 63/585,145, filed Sep. 25, 2023, the contents of which are hereby incorporated by reference.

### TECHNICAL FIELD

The present disclosure relates to the visual display of data, and more particularly to displaying a multi-axis score to provide improved guidance for bidding to bidders in an auction.

### BACKGROUND

An “invoice auction” is an auction in which bidders submit competing bids on the right to pay a discounted amount immediately to the current holder of an invoice in return for the right to collect the full amount of the invoice on its eventual due date. In this context, the “buyer” or “customer” is the entity that bought merchandise or services and will need to pay the invoice, the “seller” or “supplier” is the entity that received the order and has issued the invoice and is awaiting payment, and the “bidder” is the entity that bids on the opportunity to pay the supplier the discounted amount but eventually receive the full amount of the payment for the invoice from the customer. Typically the supplier has already delivered the merchandise or performed the service when the supplier puts the invoice up for auction but this is not a requirement.

An invoice auction is typically carried out as part of financial factoring, i.e., the sale of a company's accounts receivable to a “factor” (i.e., the bidder). As described above, the factor pays immediately in exchange for a discount and recovers its investment with its respective return by collecting the value of the accounts receivable.

In the “traditional factoring” approach to financial factoring, although the bidder has the right to collect on the invoice, the buyer otherwise has no particular legal relationship to the bidder or auction house. In this situation, seller may provide a promise to pay the invoice amount if the buyer fails to pay; in brief the seller is jointly liable with the buyer for the invoice. This can be termed having recourse against the seller. However, it is also possible for the seller to not provide recourse, e.g., the agreement may simply transfer the right to collect with no recourse for the bidder to recover from the seller if the buyer fails to pay.

On the other hand, in a “reverse factoring” approach to financial factoring, the buyer enters into an agreement with either the bidder or the auction house to pay the invoice. A large institutional buyer might do so to permit their vendors (the suppliers) to more easily manage their account receivable and thus improve vender relationships.

### SUMMARY

In one aspect, one or more non-transitory computer-readable media store instructions that, when executed by one or more computers of an invoice auction processing computer system, cause the one or more computers to maintain at least one data store defining a respective account for a customer and/or a supplier, and for each of a plurality of bidders, receive a request to submit an invoice for auction, wherein one of the customer or supplier is a responsible party, collect and store as data an identity of the supplier for the invoice, an identity of the customer for the invoice, an amount of the invoice, and a payment due date for the invoice, generate a first score that represents a likelihood that the responsible party will default on an auctioned invoice and a second score that represents a likelihood of collection from the responsible party on a defaulted auctioned invoice, for each respective bidder of one or more bidders from the plurality of bidders, cause a display of a bidder computer system of the respective bidder to display a graph having a first axis corresponding to the likelihood that the responsible party will default on an auctioned invoice and a second axis corresponding to the likelihood of collection from the responsible party on a defaulted auctioned invoice, and display an indicia at a location in the graph corresponding to the first score and the second score, and receive from at least one bidder of the one or more bidders a bid for the invoice.

In another aspect, one or more non-transitory computer-readable media store instructions that, when executed by one or more computers of an invoice auction processing computer system, cause the one or more computers to maintain at least one data store defining a respective account for a customer and/or a supplier, and for each of a plurality of bidders, receive a request to submit an invoice for auction, collect and store as data an identity of the supplier for the invoice, an identity of the customer for the invoice, an amount of the invoice, and a payment due date for the invoice, generate a first score that represents a likelihood that the customer will fulfill payment on an auctioned invoice and a second score that represents a likelihood that the supplier will fulfill payment on the auctioned invoice, for each respective bidder of one or more bidders from the plurality of bidders, cause a display of a bidder computer system of the respective bidder to display a graph having a first axis corresponding to the likelihood that the customer will fulfil payment on the auctioned invoice and a second axis corresponding to the likelihood that the supplier will fulfil payment on the auctioned invoice, and display an indicia at a location in the graph correspond to the first score and the second score, and receive from at least one bidder of the one or more bidders a bid for the invoice.

In another aspect, one or more non-transitory computer-readable media storing instructions that, when executed by one or more computers of an invoice auction processing computer system, cause the one or more computers to maintain at least one data store defining a respective account for a customer and/or a supplier, and for each of a plurality of bidder, receive a request to submit an invoice for auction, collect and store as data an identity of the supplier for the invoice, an identity of the customer for the invoice, an amount of the invoice, and a payment due date for the invoice, generate a first score that represents a likelihood that the supplier will default on an auctioned invoice, a second score that represents a likelihood of collection from the supplier on a defaulted auctioned invoice, and a third score that represents a financial strength of the customer, generate a combined risk level score from a calculated combination of the first score, the second score, and the third score, for each respective bidder of one or more bidders from the plurality of bidders, cause a display of a bidder computer system of the respective bidder to display the combined risk level score, and receive from at least one bidder of the one or more bidders a bid for the invoice.

In another aspect, one or more non-transitory computer-readable media storing instructions that, when executed by one or more computers of an invoice auction processing computer system, cause the one or more computers to maintain at least one data store defining a respective account for a customer and/or a supplier, and for each of a plurality of bidders, for each respective bidder of one or more bidders from the plurality of bidders, cause a display of a bidder computer system of the respective bidder to display a user interface, the user interface including a plurality of scores and a plurality of interface elements to set a plurality of thresholds values with each respective interface element setting a threshold value for an associated score, receive a request to submit an invoice for auction, collect and store as data an identity of a supplier for the invoice, an identity of a customer for the invoice, an amount of the invoice, and a payment due date for the invoice, generate a risk level value representing a risk of failure to collect on the invoice, compare the risk level value to the plurality of thresholds, wherein a highest score for which the risk level value exceeds the associate threshold value is assigned as a combined risk level score, for each respective bidder of one or more bidders from the plurality of bidders, cause a display of a bidder computer system of the respective bidder to display the combined risk level score, and receive from at least one bidder of the one or more bidders a bid for the invoice.

In another aspect, one or more non-transitory computer-readable media store instructions that, when executed by one or more computers of a computer system, cause the one or more computers to maintain at least one data store defining a respective account for a supplier and/or a customer, and for each of a plurality of bidders, for each respective bidder of one or more bidders from the plurality of bidders, cause a display of a bidder computer system of the respective bidder to display a user interface, the user interface including a plurality of scores and a plurality of interface elements to set a plurality of minimum discount rates, with each respective interface element setting a minimum discount rate for an associated score, receive from a supplier computer system a request to submit one or more invoices for auction, calculate a total invoice amount for the one or more invoices, generate a risk level score representing a risk of failure to collect on the invoice, in an automated process and for each respective bidder of one or more bidders, determine the minimum discount rate set for the risk level score, receive a plurality of bids from a plurality of bidder computer systems, wherein each bid includes the minimum discount rate and a maximum amount covered, wherein each bid from the one or more bidders includes the minimum discount rate determined from the risk level score, set an acceptable discount rate equal to an initial discount rate, set a remaining group of bids to be the plurality of bids, at a close of bidding, in an iterative loop determine whether any bid from the remaining group of bids has a minimum discount rate equal to or greater than the acceptable discount rate, if no bid is determined to have a minimum discount rate greater than the acceptable discount rate, then decrement the acceptable discount rate by a bid increment, and repeat the loop, if a given bid is determined to have a minimum discount rate equal to or greater than the acceptable discount rate, then calculate a total amount covered by summing the maximum amount covered of each bid, other than the given bid, of the remaining group of bids, determine whether the total amount covered is equal to or greater than the total invoice amount, remove the given bid from the remaining group of bids, if the total amount covered is determined to be equal to or greater than the total invoice amount, then decrement the acceptable discount rate by the bid increment, and repeat the loop, if the total amount covered is determined to be less than the total invoice amount, then exit the loop, allocate the invoices among the one or more bids of the remaining group of bids, and set a final discount rate to be the acceptable discount rate.

Implementations may include one or more of the following features. There may be instructions to, for each respective bidder of one or more bidders from the plurality of bidders, cause the user interface to including a second plurality of interface elements to set a plurality of maximum amount covered values with each respective interface element setting a maximum amount covered value for an associated score. The user interface may include a plurality of rows, with each row including a score, a first user interface element to set the minimum discount rate for the score, and a second user interface element to set the maximum amount covered for the associate score.

In another aspect, one or more non-transitory computer-readable media storing instructions that, when executed by one or more computers of an invoice auction processing computer system, cause the one or more computers to maintain at least one data store defining a respective account for a customer and/or a supplier, and for each of a plurality of bidders, receive a request to submit a transaction for auction, wherein one of the customer or supplier is a responsible party, collect and store as data an identity of the supplier for the transaction, an identity of the customer for the transaction, a bidding variable for the transaction, and a due date for the transaction, generate a first score that represents a likelihood that the responsible party will default on the transaction and a second score that represents a likelihood of enforcement on a defaulted transaction, for each respective bidder of one or more bidders from the plurality of bidders, cause a display of a bidder computer system of the respective bidder to display a graph having a first axis corresponding to the likelihood that the responsible party will default on the transaction and a second axis corresponding to the likelihood of enforcement of a defaulted transaction, and display an indicia at a location in the graph correspond to the first score and the second score, and receive from at least one bidder of the one or more bidders a bid for the transaction.

In another aspect, one or more computer-readable media store instructions that, when executed by one or more computers of an invoice computer system, cause the one or more computers to maintain at least one data store defining a respective account for each of a plurality of suppliers, each of a plurality of customers, and each of a plurality of bidders. For each respective customer of the plurality of customers, a respective multi-axis score is generated that includes a first portion calculated from a first plurality of input variables to represent a likelihood that the respective customer will default on an auctioned invoice and a second portion calculated from a second plurality of different input variables to represent a likelihood of collection on a defaulted auctioned invoice. A request to submit an invoice for auction is received from a supplier computer system. An identity of a supplier for the invoice, an identity of a customer for the invoice, an amount of the invoice, and a payment due date for the invoice are collected and stored as data. For each respective bidder of one or more bidders from the plurality of bidders, a display of a bidder computer system of the respective bidder is caused to display at least the amount of the invoice, the payment due date for the invoice, and the first and second portion of the respective multi-axis score corresponding to the customer identified for the invoice so as to be simultaneously visible to a respective bidder. A bid for the invoice is received from at least one bidder of the one or more bidders.

Implementations may include one or more of the following features.

There may be instructions that cause the multi-axis score to be displayed as a two-character code, e.g., two alpha-numeric characters. There may be instructions that cause the multi-axis score to be displayed with a one of the two characters being a letter and a second of the two characters being a number. There may be instructions that cause the multi-axis score to be displayed as a matrix having an indicia placed a cell of the matrix corresponding to the multi-axis score. The first plurality of input variables or the second plurality of different input variables include values calculated from stored historical transactions involving of prior invoices of the customer.

There may be instructions to calculate the first portion by performing a weighted summation or average of values for the first plurality of input variables to generate a first weighted sum or average. There may be instructions to convert the first weighted sum or average to one of a preset number of first possible values. The preset number of first possible values may be two to six possible values. The instructions to convert the first weighted sum or average to one of a preset number of first possible values may include instructions to look up a value in a first lookup table. There may be instructions to calculate the second portion by performing a weighted summation or average of values for the second plurality of input variables to generate a second weighted sum or average. There may be instructions to convert the second weighted sum or average to one of a preset number of second possible values. The preset number of second possible values may be two to six possible values. The instructions to convert the second weighted sum or average to one of a preset number of second possible values may include instructions to look up a value in a second lookup table.

Possible advantages may include, but are not limited to, one or more of the following.

Presenting a multi-axis score permits a bidder to more quickly understand the financial status and risk level of the customer. Similarly, presenting a score in conjunction with a two-axis graph permits a bidder to more quickly understand the financial status and risk level of the buyer and/or the supplier (e.g., the buyer in a reverse factor or traditional factor without recourse, or both buyer and seller in a traditional factoring with recourse). For example, due to the simultaneous display of this data in a multi-axis format, the bidder can understand both the likelihood of payment of auctioned invoices by the liable party or parties, and the general financial strength of the liable party or parties, e.g., in case of having to litigate to collect an invoice won at auction. This in turn permits the bidder to make decisions more quickly on whether to submit a bid and the terms of the bid, e.g., what discount to offer the supplier on the invoice.

A bidder may select their own confidence levels through a user interface, thus personalizing their risk tolerance. A bidder may identify certain customers as pre-approved for bids, and bypass calculation of the multi-axis score. Submission of bids can be automated.

The details of one or more implementations are set forth in the accompanying drawings and the description below. Other aspects, features, and advantages will be apparent from the description and drawings, and from the claims.

### BRIEF DESCRIPTION OF DRAWINGS

FIG. 1 illustrates an example network to perform an electronic invoice auction.

FIG. 2A illustrates an example method for calculating a customer risk score.

FIG. 2B illustrates analysis of a financial factoring for an invoice auction.

FIG. 3A illustrates an example portion of a visual display for the bidder in the invoice auction.

FIG. 3B illustrates an example portion of another implementation of a visual display for the bidder in the invoice auction.

FIG. 3C illustrates an example portion of a visual display for the bidder that includes a graph of a 2D risk curve.

FIG. 4A illustrates another example portion of a visual display for the bidder that includes a two-character alphanumeric code.

FIG. 4B illustrates an example portion of another visual display for the bidder in which a location of a two-axis score is displayed graphically.

FIG. 5 illustrates an interface for a bidder to select a risk curve and/or automate participation in an invoice auction.

FIG. 6 illustrates a flow chart of a method of conducting an electronic invoice auction.

FIGS. 7-13 are schematic graphs illustrating multiple invoices and multiple bids across multiple rounds in an electronic invoice auction.

FIG. 14 is a schematic diagram of an example of a generic computer system.

### DETAILED DESCRIPTION

Invoice auctions currently occur with the bidders only having limited information concerning the risks of collecting from a customer or supplier on a winning bid. Although bidders might attempt to perform their own investigation into the customer or supplier to ascertain a risk level, this is cumbersome and time-consuming. Moreover, even if an auction system provides information regarding the financial strength of a customer (and thus the relative risk in collection), it may be presented as “raw data” in a manner that is difficult for the bidder to absorb or act on, particularly if this raw data is from multiple sources.

A technique to address these issues is to calculate, for at least one liable party, two individual scores representing different aspects of financial risk, and then combine those scores to generate an overall risk score from the individual scores. This overall risk score can be displayed to the bidders or used for an automated determination of whether to bid and values for the bid parameters. For reverse factoring or traditional factoring without recourse the two scores can be generated for the buyer. Where multiple parties are liable, e.g., traditional factoring with recourse, one or two scores can be generated for the seller, and an additional score representing an aspect of financial risk of the byer can be generated, and the two or three scores can be combined to generate the overall risk score.

An additional technique is to display the bidder the overall risk score on a multi-axis risk curve, e.g., a position labelled with a score in a two-axis graph, rather than as raw data. “Rolling up” raw data into a single overall risk score that is displayed in a two-axis graph with the different axes indicating different components contributing to the risk can provide easy-to-understand and easy-to-mentally process guidance on the risks involved in bidding for the collection opportunity, thus permitting the bidder to make decisions more quickly on whether to submit a bid or engage in bidding, along with the terms of the bid(s).

A similar technique is to display to the bidder a multi-axis score, e.g., a two-axis score with two separate values, rather than as raw data. This multi-axis score can include both previous auction information (e.g., a first axis of the score) as well as available customer financial information (e.g., a second axis of the score).

In both techniques, auction information is separated and coalesced from supplier and customer financial information to be presented in an integrated manner, providing a bidder with a simplified guide to the complex multi-data conditions, enabling a faster decision on an appropriate bid.

In some instances, the decision on whether to submit a bid or engage in bidding, along with the terms of the bid, can be performed by the bidder in a computer-based programmatic manner without user intervention, i.e., in an “automated” manner.

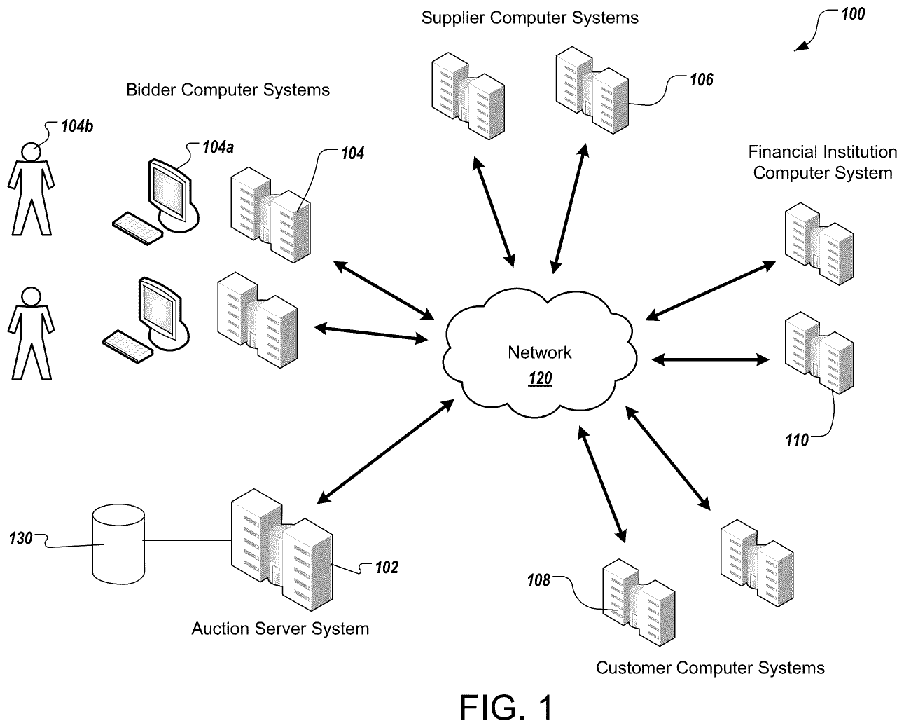

FIG. 1 illustrates an example system 100 used to conduct an auction, e.g., an invoice auction. An auction server system 102 is connected through a communications network 120, e.g., the Internet, at least to multiple bidder computer systems 104 and multiple supplier computer systems 106. Optionally, the auction server system 102 can be connected through the communications network 120 to one or more customer computer systems 108, and/or to one or more financial institution computer systems 110.

The auction server system 102 maintains a data store 130, e.g., one or more databases, that defines an account and stores account data for each respective participant in the auction, i.e., each bidder and each supplier and each customer. The account data includes a unique user ID for the respective participant, as well as the participant's name and contact information, e.g., the participant's government ID number (if applicable), address, telephone number, and email address, and the participant's password or PIN. The account data can also include financial information sufficient for making (for the bidder at the acceptance of the bid and for the customer at the time the invoice is due) or receiving (for the supplier at the acceptance of the bid and for the bidder at the time the invoice is due) payments, e.g., a name of a financial institution, account number, and bank routing number (also known as ABA number), such that the payment from the bidder to the supplier can be processed upon a successful bid. Of course, the exact format or nature of financial information can depend on the country, e.g., accounts in Mexico may store a CLABE (Clave Bancaria Estandarizada) number.

In some implementations, at the acceptance of the bid, the auctioneer receives payment from the bidder, takes a commission from that payment, and then routes the remainder of the payment to the supplier. In some implementations, at the time the invoice is due, the auctioneer receives payment from the customer, takes a commission from that payment, and then routes the remainder of the payment to the bidder.

For the customers, the data store will store additional information, discussed below, that permits generation of a multi-axis score for each respective customer or supplier. In some implementations, the multi-axis score can be generated on a transaction by transaction basis. In some implementations, the multi-axis score can be generated and stored in the data store for use in subsequent transactions involving the same customer or supplier.

The suppliers are likely interested in registering with the auction server system 102 in order to be able to auction off invoices to quickly raise capital. The bidders are likely interested in registering with the auction server system 102 for the opportunity to make a profit, should their bid be successful, between the full amount of the invoice and the discounted amount. The customers must be pre-registered in the auction server system 102 so that the operator of the auction server system 102 can collect the customer information to generate the multi-axis score; the customer may be induced to register with the auction server system 102 by the supplier providing beneficial terms to the original invoice in return for the customer accepting that their invoices will be in the auction. In case of traditional factoring the customer may not register, however, the auctioneer creates a record that requires only public information.

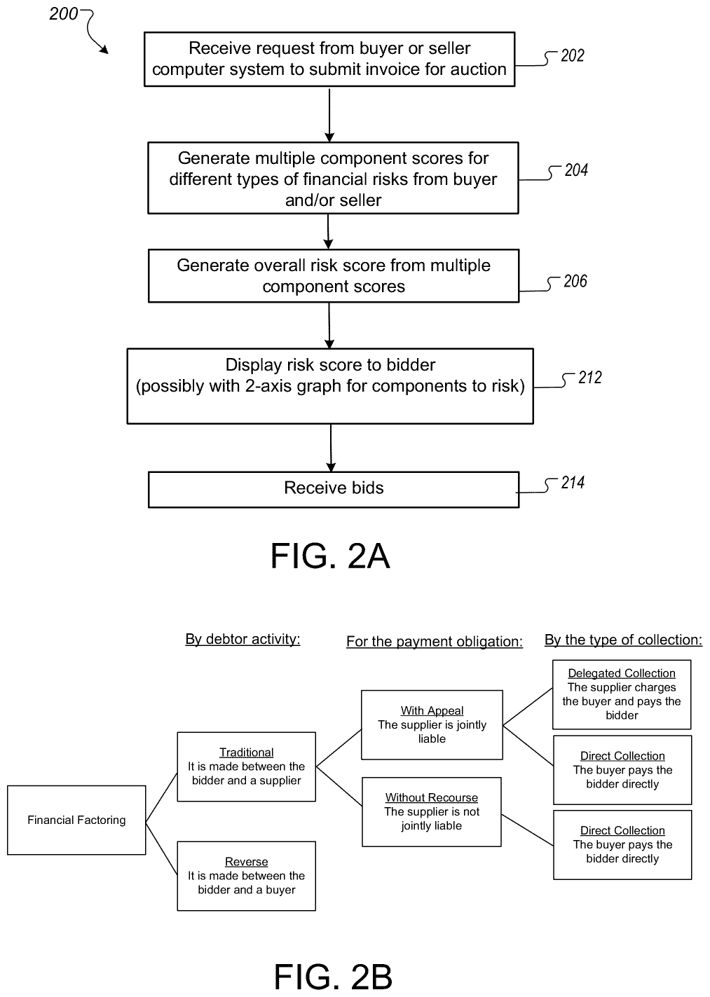

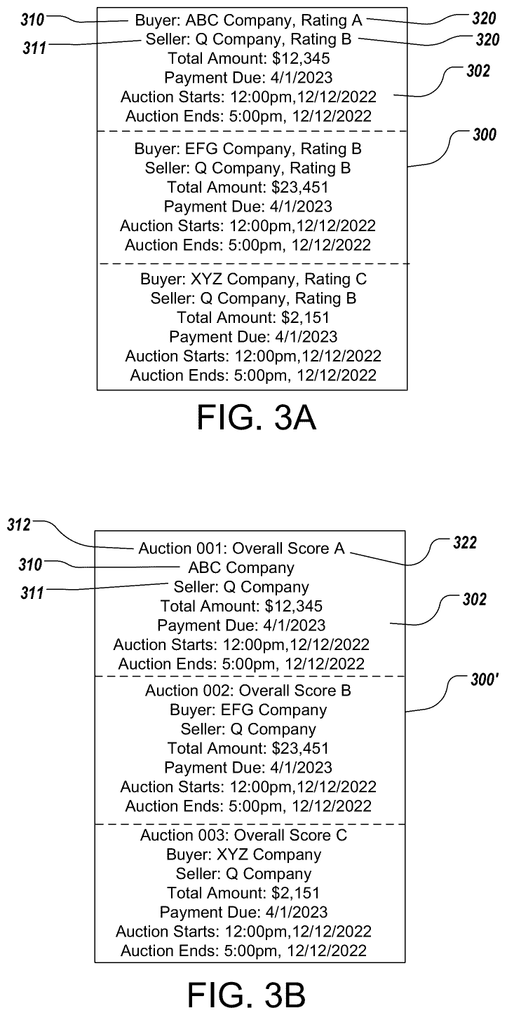

The auction server system 102 is configured to receive and recognize a request from a supplier computer system 106 to submit for auction a group of invoices (i.e., multiple invoices that form a “lot” of invoices) of the associated supplier (see step 202 in FIG. 2A). A variety of techniques to receive this request are possible. For example, a user of the supplier computer system 106 can use a general-purpose web-browser program, e.g., Internet Explorer or Chrome, to access a web-browser accessible website provided by the auction server system 102. As another example, the user of the supplier computer system 106 can run a dedicated application that is provided by the auction provider and configured for secure communication with the auction server system 102. As another example, the request can be sent and received by electronic mail, whose content may be interpreted by the auction server, thereby deriving appropriate invoice information for auction. The auction server system 102 collects the pertinent information regarding the invoice: the identity of the supplier, the identity of the customer, the amount of the invoice, and the payment deadline for the customer. The nature of the merchandise or services being invoiced may also be collected. This information can be extracted by auction server system 102 from an image of the invoice provided, e.g., uploaded by the supplier computer system 106 or attached to an email. For example, the auction server system 102 could perform optical character recognition (OCR) on an image of the invoice. Alternatively, the supplier computer system 106 may provide this information in tabular form as part of the request, e.g., the necessary information can be required from the user by the dedicated application before the request can be submitted.

Alternatively, e.g., for a reverse factoring transaction, the submission can be made by the buyer through the customer computer systems 108. This would include the same type of information as described above.

The auction server system 102 identifies the supplier entity and customer entity for the invoice using one or more identifiers described above. For traditional factoring, the supplier entity can be identified simply from the party making the submission, and the customer entity can be determined from the invoice. Conversely, for reverse factoring, the supplier entity can be identified from the invoice, whereas the customer entity can be determined simply from the party making the submission.

As illustrated in FIG. 2B, the auction server system 102 stores data identifying the type of factoring, e.g., traditional or reverse, for the invoice sale. For a traditional factoring invoice sale, the auction server system 102 also stores data identifying the type of supplier guarantee, e.g., with or without recourse, and the type of collection, e.g., direct or delegated, for the invoice sale. This information can be obtained by the auction house by analysis of documents related to the invoice, or be submitted by the buyer and/or seller and look up tables from previous auction with related or overlapping information.

The auction server system 102 generates multiple component scores indicating different types of financial risk from the buyer and/or seller (see step 204 in FIG. 2A). For example, two scores can include a “feasibility of recovery” score (also referred to as a “financial score”), and a “probability of compliance” score (also referred to as a “guarantor score”).

For reverse factoring and for traditional factoring without recourse, the auction server system 102 can generate the two scores for the buyer, i.e., the scores represent risks to the bidder on collection from the buyer.

For traditional factoring with recourse, the auction server system 102 can generate the two scores for the supplier, i.e., the scores represent risks to the bidder on collection from the supplier. Moreover, for traditional factoring with recourse, the auction server system 102 can generate one or more additional scores for the buyer, i.e., the additional score(s) represent risk(s) on collection from the buyer and from any other entities that provide a guarantee of recourse. In some implementations, only the “feasibility of recovery” score is generated for the buyer. In some implementations, both the “feasibility of recovery” score and the “probability of compliance” score are generated for the buyer.

These two, three or four components scores can then be combined to generate an overall risk score (see step 206 in FIG. 2A). However, each of the “feasibility of recovery” score and a “probability of compliance” score may also be presented distinct from each other on a display screen window for the bidder.

The “probability of compliance” score is a scaled score indicating the degree to which a party, i.e., the buyer or seller, has adequate financial resources and a corporate history suggesting a likelihood to pay the invoice when the invoice payment date is (or dates are) reached. Stated differently, the probability of compliance score can be considered an indication of the likelihood that the party will default on payment. The probability of compliance score can be calculated based on public data available from government or credit bureaus and from financial statements from the party, as well as non-public data such as data from past auctions involving the party.

Calculation of the “probability of compliance” score can be performed using a kernel product function:

K(Wᵢ,Xᵢ)

where X₁, X₂, . . . , X_{N} are the values of the input variables, and W₁, W₂, . . . , W_{N} are the weights.

For example, calculation of the “probability of compliance” score can be performed using a weighted sum (or weighted average) o. The weighted average can be represented as:

$${W}_{1} {X}_{1} + {W}_{2} {X}_{2} + … + {W}_{N} {X}_{N}$$

where X₁, X₂, . . . , X_{N} are the values of the input variables, and W₁, W₂, . . . , W_{N} are the weights.

Alternatively, calculation of the “probability of compliance” score can be performed using a logistic regression model that considers the various data inputs. In particular, the logistic regression can be represented as

$$P ( {X}_{1} , {X}_{2} , … , {X}_{N} ) = \frac{1}{1 + {e}^{- ( {β}_{0} + {β}_{1} {X}_{1} + {β}_{2} {X}_{2} + … + {β}_{N} {X}_{N} )}}$$

where P is the probability of compliance score, X₁, X₂, . . . , X_{N} are the values of the input variables, and β₀, β₁, β₂ . . . β_{N} are constants that can be determined by a goodness of fit using sample data.

In some implementations, the output of the kernel function or logistic regression model is fed into a look-up-table to convert the output into the score, although this may not be required.

Possible input variables for the “probability of compliance” score include one or more of the following characteristics of the party: the “acid test” of current assets divided by current liabilities, their liquidity ratio of the party, the net debt to EBITDA (earnings before interest, taxes, depreciation, and amortization) of the party, the interest coverage ratio of the party, the debt coverage of the party, the debt to capital ratio of the party, the gross or net sales trend of the party, the operative margin trend of the party, the net margin trend of the party, the number of years in business of the party, the business sector risk rating for the business sector the party, the credit bureau rating of the party, the legal bureau rating of the party, percentage of late payments by the party, average number of days of delay in payment for the party, percentage of defaults by the party, and size of defaults by the party.

Values for some of these variables, e.g., bureau ratings and tax information, can be obtained by operators of the auction server system 102 from public sources, e.g., a tax ministry, credit bureau, or legal bureau. Values for some of these variables, e.g., assets, liabilities, liquidity, etc., can be obtained by operators of the auction server system 102 from public financial statements of the customer or supplier, e.g., Security and Exchange Commission (SEC) or tax filings. Values for some of these variables, e.g., late payments or defaults, can be obtained by operators from prior history of the customer or supplier with the auction server system 102.

The “feasibility of recovery” score is also a scaled score, and the feasibility of recovery score indicates the degree to which the transaction is backed, e.g., by collateral, by a separate guarantor, etc. So the guarantor score can be considered an indication of the likelihood that that the bidder will be able to collect on the customer's invoice should a default occur.

For an invoice auction using traditional factoring, the “feasibility of recovery” score for the supplier can be assigned by the auctioneer based on the available backing. For example, the auctioneer can assign a score S based on the criteria illustrated in Table 1 below:

TABLE 1

| Criteria | Feasibility Score S |
|---|---|
| Invoice only | S1 |
| Supplier promissory note | S2 |
| Supplier promissory note with non-liquid assets | S3 |
| Supplier promissory note with liquid assets | S4 |

where S1, S2, S3 and S4 is the resulting score with S1<S2<S3<S4.

The “invoice only” is the highest level of risk, as there is no backup or recourse for enforcement of the debt. “Supplier promissory note” refers to a written agreement between the supplier and the bidder or auction house to pay the invoice amount. “Supplier promissory note with non-liquid assets” refers to such written agreement, with a non-liquid asset, e.g., real estate, as collateral. Finally, “supplier promissory note with liquid assets” refers to such a written agreement, with a liquid asset, e.g., a bank account, as collateral.

For an invoice auction using reverse factoring, the “feasibility of recovery” score of for the buyer can be assigned by the auctioneer based on the available backing. For example, the auctioneer can assign a score B based on the criteria illustrated in Table 2 below:

TABLE 2

| Criteria | Feasibility Score B |
|---|---|
| Invoice only | B1 |
| Buyer promissory note | B2 |
| Buyer promissory note with non-liquid assets | B3 |
| Buyer promissory note with liquid assets | B4 |

where B1, B2, B3 and B4 is the resulting score with B1<B2<B3<B4.

The “invoice only” is the highest level of risk, as there is no backup or recourse for enforcement of the debt. “Buyer promissory note” refers to a written agreement between the customer and the bidder or auction house to pay the invoice amount. “Buyer promissory note with non-liquid assets” refers to such written agreement, with a non-liquid asset, e.g., real estate, as collateral. Finally, “buyer promissory note with liquid assets” refers to such a written agreement, with a liquid asset, e.g., a bank account, as collateral.

Calculation of the “feasibility of collection” score can be performed using a kernel product function:

K(Vᵢ,Yᵢ)

where V₁, V₂, . . . , V_{N} are the values of the input variables, and Y₁, Y₂, . . . , Y_{N} are the weights.

For example, the calculation of the “feasibility of recovery” score can be performed using a weighted sum (or weighted average) of values followed by a look-up-table to convert the weighted average into the score. The weighted average can be represented as:

$$S = {V}_{1} {Y}_{1} + {V}_{2} {Y}_{2} + … + {V}_{M} {Y}_{M}$$

where Y₁, Y₂, . . . , Y_{M} are the values of the input variables, and V₁, V₂, . . . , V_{N} are the weights.

Possible input variables for the “feasibility of recovery” include one or more of the following characteristics of the customer: the type of factoring (direct or inverse), the collection model (direct or delegated), whether an IOU from a third party is available (1 for yes or 0 for no), the transaction amount divided by annualized sales, the outstanding balance divided by annualized sales, the term of the transaction, whether there is a guarantor (1 for yes or 0 for no), 15inanceancial strength of the guarantor, whether there is collateral (1 for yes or 0 for no), and the collateral coverage ratio (collateral divided by transaction size). Some of the factors involving auction history of the customer, e.g., percentage of late payments by the customer, average number of days of delay in payment, percentage of defaults by the customer, and size of defaults by the customer, can be used as inputs to the guarantor score instead of or in addition to the financial score.

Values for some of these variables, e.g., type of factoring, collection model, etc., can be obtained by operators of the auction server system 102 from the documents submitted for the invoice auction. Values for some of these variables, e.g., concerning guarantor or collateral, can come from the terms of the invoice itself or from a long term purchase agreement covering many invoices.

The risk level score can be generated from the component scores, e.g., “feasibility of recovery” score and the “probability of compliance” score. The risk level score can have a limited number of possible values, e.g., two to six possible values, e.g., three or four or five values. For example, the risk level score can be a letter score, e.g., “A”, “B”, “C”, “D” or “F” (best to worst) assuming five possible values. Alternatively, the risk level score can be a numeric, e.g., a whole number, e.g., “1”, “2”, “3” or “4” (best to worst) assuming four possible values.

In particular, where just two scores are generated, e.g., for reverse factoring, an overall risk level value R can be calculated from the “feasibility of recovery” score and the “probability of compliance” score. This overall risk level value R can also be referred to as a “confidence level.”

For example, the overall risk level value R for the buyer in reverse factoring can be calculated as a Euclidian distance:

$$R = \sqrt{{P}^{2} + {B}^{2}}$$

or as a weighted root mean square:

$$R = \sqrt{{U}_{P} {P}^{2} + {U}_{B} {B}^{2}}$$

where U_{P} and U_{B} are the weights.

Where just three or more scores are generated, e.g., for traditional factoring, a risk level value R can be calculated from the “feasibility of recovery” score, the “probability of compliance” score, and the additional score. In particular, e.g., for traditional factoring with recourse, a risk level value R can be calculated from the “feasibility of recovery” P1 score for the supplier, the “probability of compliance” score S for the supplier, and a “feasibility of recovery” score P2 for the buyer.

In some implementations, the overall risk level risk level value R can be calculated as a Euclidian distance.

$$R = \sqrt{P {1}^{2} + {S}^{2} + P {2}^{2}}$$

or as a weighted root mean square:

$$R = \sqrt{{U}_{P 1} P {1}^{2} + {U}_{S} {S}^{2} + {U}_{P 2} P {2}^{2}}$$

where U_{P1}, U_{P2}, and U_{S} are the weights.

Alternatively, the overall risk level value R can be calculated using a weighted sum (or weighted average) of values followed by a look-up-table to convert the weighted average into the score. The weighted average can be represented as:

$$R = {U}_{P 1} P 1 + {U}_{S} S + {U}_{P 2} P 2$$

where U_{P1}, U_{P2}, and U_{S} are the weights.

In some implementations, e.g., for traditional factoring with recourse, the values for the weights can depend on the type of collection. For example, sample values for U_{P1}, U_{P2}, and U_{S} are given in Table 3.

TABLE 3

| Factoring | Guarantee | Collection | U_{P1} | U_{S} | U_{P2} |
|---|---|---|---|---|---|
| Traditional | With recourse | Direct | 20% | 10% | 70% |
| Traditional | With recourse | Delegated | 15% | 10% | 75% |

Finally the overall risk level score can then be generated from the overall risk level value R, e.g., using a lookup table. A sample lookup table with two digit precision is shown below as Table 4, with risk level ranges and scores arranged in increasing level of risk:

TABLE 4

| R | Score |
|---|---|
| 0.95-1.0 | “A” |
| 0.90-0.94 | “B” |
| 0.86-0.89 | “C” |
| 0.82-0.85 | “D” |
| Below 0.82 | “F” |

Rather than ranges, the lookup table can store a set of threshold values (e.g., 0.95, 0.90, 0.86, 0.82 for Table 4). The highest score for which the risk level value exceeds the threshold value can be assigned as the risk level score.

The overall risk level score can be generated each time a new company that wants to discount invoices at auction creates an account. In addition, an existing risk level score can be refreshed periodically, e.g., every 3 to 6 months, in case the company wants to continue to auction more invoices.

A variety of techniques are possible for the bidder to participate in the auction. For example, a user 104b of the bidder computer system 104 can use a general-purpose web-browser program, e.g., Internet Explorer or Chrome, to access a web-browser accessible website provided by the auction server system 102. As another example, the user 104b of the bidder computer system 104 can run a dedicated application that is provided by the auction provider and configured for secure communication with the auction server system 102.

For the auction, the auction server system 102 sends a message out to each bidder computer system 104 that has indicated interest in receiving auctioned invoices. The message includes the pertinent information for the invoice, e.g., amount, term, identity of supplier, and identity of customer, as well as the risk level score. The bidders 104b may select to review, or instruct the auction server system 102 to send, only certain invoices. For example, the auction server system 102 can implement a filter system that permits a bidder 104b to receive invoices within a certain size range, of type of good or service, within a certain term, etc.

The auction server system 102 causes the display 104a for the bidder 104b to display the risk level score (see step 212 of FIG. 2) along with the pertinent information for the invoice, e.g., amount, term, identity of supplier, and identity of customer. As one example, if the bidder is using a general-purpose web-browser, then the auction server system 102 can generate HTML that when rendered by the general-purpose web-browser causes the two-axis score to be displayed. As another example, if the bidder is using a dedicated application, then the dedicated application can be configured with code that causes the two-axis score to be displayed.

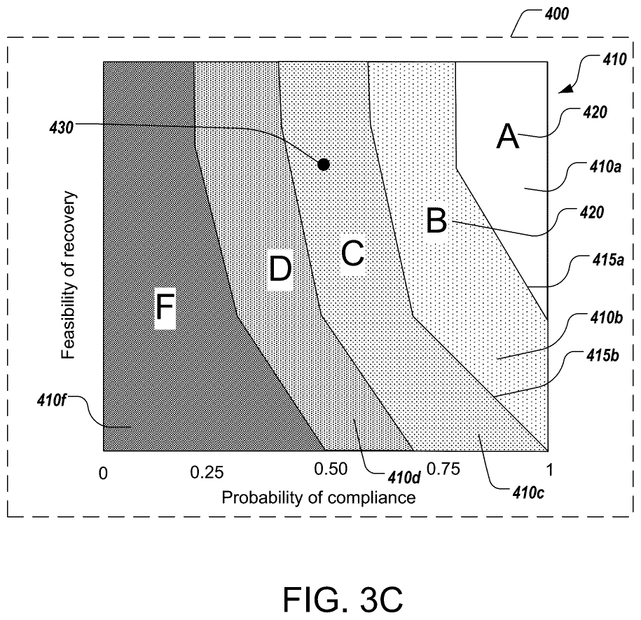

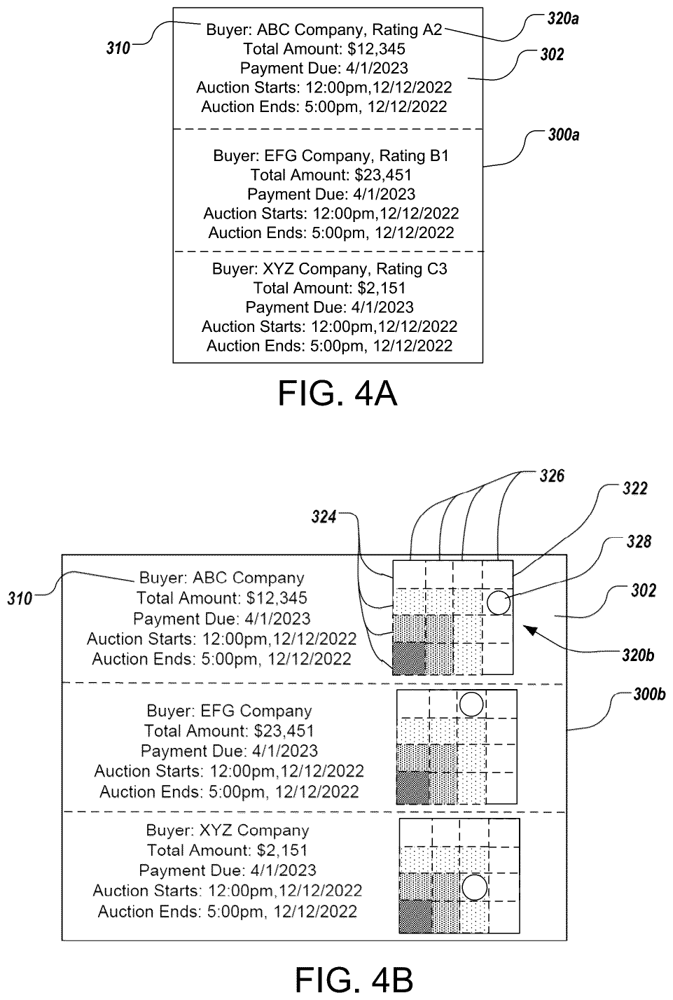

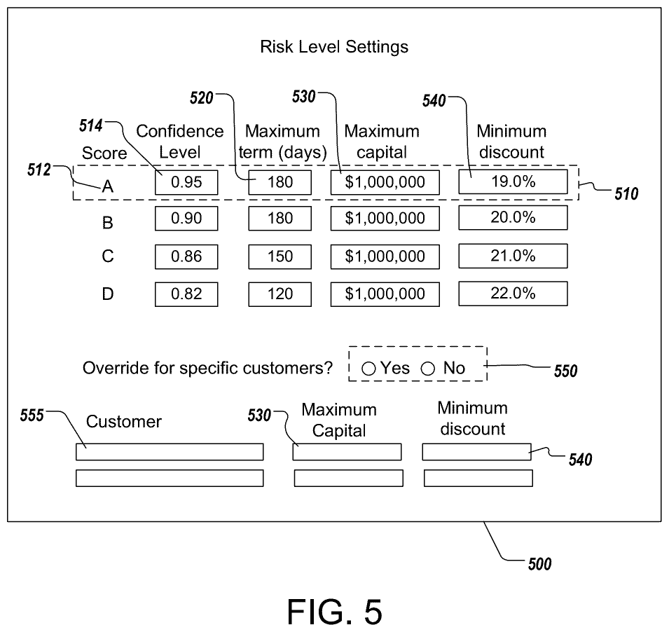

Turning to FIG. 3A, the auction server system 102 can cause the display 104a to display a table 300 with each row 302 in the table 300 includes an entry for the customer 310 (identified as the “Buyer”) or the supplier 311 (identified as the “Seller”). In addition, a risk level score 320 is displayed in proximity, e.g., immediately following, the entry for the customer or supplier. Here the risk level score 320 is displayed simply as an alphabetic code. It also can be a two-character alphanumeric code or a two-digits numeric code.

Turning to FIG. 3B, the auction server system 102 can cause the display 104a to display a table 300′ that is similar to table 300. However, the table 300′ includes a single overall risk level score 322, which can be displayed in proximity, e.g., immediately following, an entry 312 identifying the transaction.

FIG. 3C illustrates a portion 400 of a display 104a for the bidder. In particular, the auction server system 102 can cause the display 104a to display a two-axis graph 410. The two-axis graph 410 can be displayed upon indication of a request by the bidder. For example, the overall risk level score 320 can be implemented as a hyperlink, and the two-axis graph 410 can be displayed if the bidder clicks on the risk level score 320. Alternatively or in addition, the two-axis graph 410 can be displayed within a display screen dedicated information regarding the customer or supplier, e.g., the two-axis graph 410 could be displayed in addition to data such as the address, yearly sales, number of employees, etc., of the customer or supplier.

In the two-axis graph 410, one axis, e.g., the horizontal axis, corresponds to the “probability of compliance” score, and the other axis, e.g., the vertical axis, corresponds to the “feasibility of recovery” score. The graph is separated into multiple zones 410a, 410b, 410c, 410d, 410f, corresponding to the possible risk level scores, e.g., A, B, C, D, F.

For an invoice auction using traditional factoring, the “feasibility of recovery” score and “probability of compliance” score are the scores generated for the supplier. For an invoice auction using reverse factoring, the “feasibility of recovery” score and “probability of compliance” score are the scores generated for the buyer.

Because the overall risk level score is calculated from both the probability of compliance score and the feasibility of recovery score, the zones form a consecutive sequence of bands, i.e., zone 410a is separated from zone 410c by zone 410b, zone 410b is separated from zone 410d by zone 410c, etc., rather like a topological or thermocline map. Separation lines 415 between the zones correspond to the particular risk level values (R) that separate the scores, e.g., line 415a corresponds to R=0.95, line 415b corresponds to R=0.90, etc. in Table 4 above.

When displayed, each zone 410a-410f can be visually distinct, e.g., displayed with a different color, pattern, or shading, to indicate a risk level for that zone and aid in easy of visually distinguishing the zone. For example, the zone 410a corresponding to the lowest risk level “A” can be green, whereas the zone 410f corresponding to the highest risk level “F” can be red.

An indicia 430 is displayed in at the coordinate in the graph 410 corresponding to the two scores, e.g., the probability of compliance score as the x-axis coordinate and the feasibility of recovery score as the y-axis coordinate in the example of FIG. 3B.

Presenting the information in this way allows a bidder to quickly understand both shorter term financial risk as well as the eventual likelihood of collection if default occurs, thereby allowing the bidders to better set an appropriate discount rate to offer for the invoice.

The risk curve illustrated by the graph 410 can be calculated using default values, e.g,. the values in Table 4. However, in some situations a bidder may wish to personalize their risk curve so that the risk curve more closely matches the bidder's risk tolerance. In addition, the as noted above, the a bidder may wish to review only certain invoices, or to adjust their risk curves.

In some implementations, rather than generate an overall risk level score, the auction server system 102 generates a two-factor (or two-axis) score. The two-factor score can include two portions: a “financial score” and a “guarantor score” as discussed above. Both scaled scores can have a limited number of possible values, e.g., two to six possible values, e.g., three or four or five values. One of the scores, e.g., the “financial score,” can be a letter score, e.g., “A”, “B”, “C” or “D” (best to worst) assuming four possible values. The other score, e.g., the “guarantor score,” can be a numeric score, e.g., a whole number, e.g., “1”, “2”, “3” or “4” (best to worst) assuming four possible values. Hence, an “A1” score means strong financial with strong backing (low risk), and a D4 means higher chance of default with no collateral (high risk). The two portions of the two-axis score can have the same number of limited number of possible values, but this is not required, e.g., one of the scores could be selected from three possible values whereas the other score can be selected from five possible values.

Calculation of the “financial score” can be performed using a weighted sum (or weighted average) of values followed by a look-up-table to convert the weighted average into the score. The weighted average can be represented as:

$${W}_{1} {X}_{1} + {W}_{2} {X}_{2} + … + {W}_{N} {X}_{N}$$

where X₁, X₂, . . . , X_{N} are the values of the input variables, and W₁, W₂, . . . , W_{N} are the weights. Possible input variables for the “financial score” are discussed above.

The weighted sum or average can then be converted to a simplified financial score using a lookup table. A sample Table 5 is shown below:

TABLE 5

| Range | Rating |
|---|---|
| 751-1000 | A |
| 501-750 | B |
| 251-500 | C |
| 0-250 | D |

Calculation of the “guarantor score” can be performed using a weighted sum (or weighted average) of values followed by a look-up-table to convert the weighted average into the score. The weighted average can be represented as:

$${V}_{1} {Y}_{1} + {V}_{2} {Y}_{2} + … + {V}_{M} {Y}_{M}$$

where Y₁, Y₂, . . . , Y_{M} are the values of the input variables, and V₁, V₂, . . . , V_{N} are the weights. Possible input variables for the “guarantor score” are discussed above.

The weighted sum or average can then be converted to a simplified guarantor score using a lookup table. A sample Table 6 is shown below:

TABLE 6

| Range | Rating |
|---|---|
| 751-1000 | 1 |
| 501-750 | 2 |
| 251-500 | 3 |
| 0-250 | 4 |

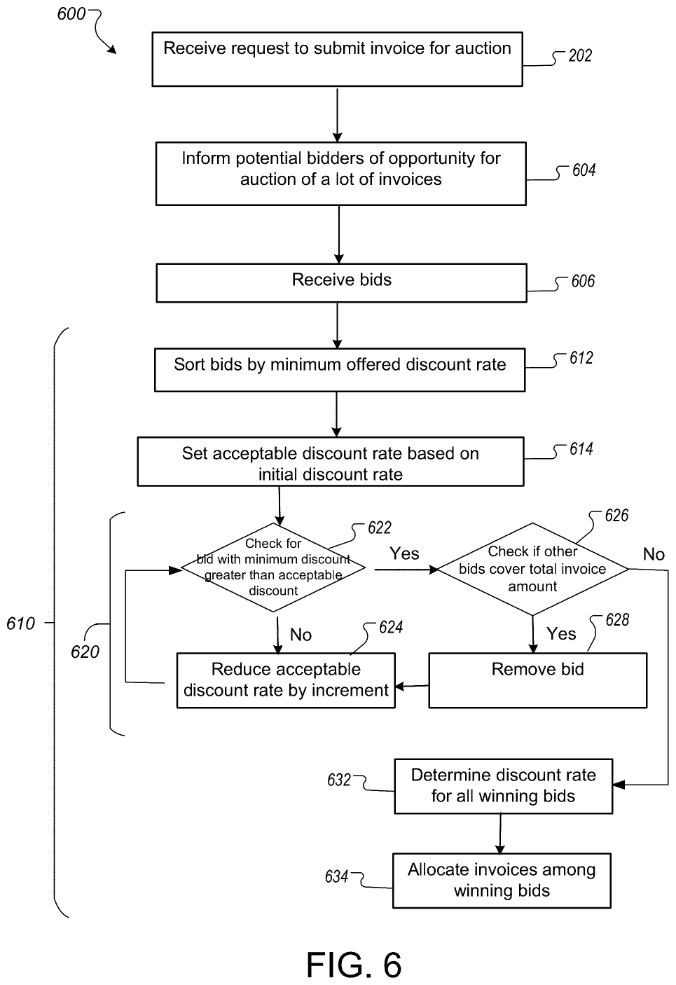

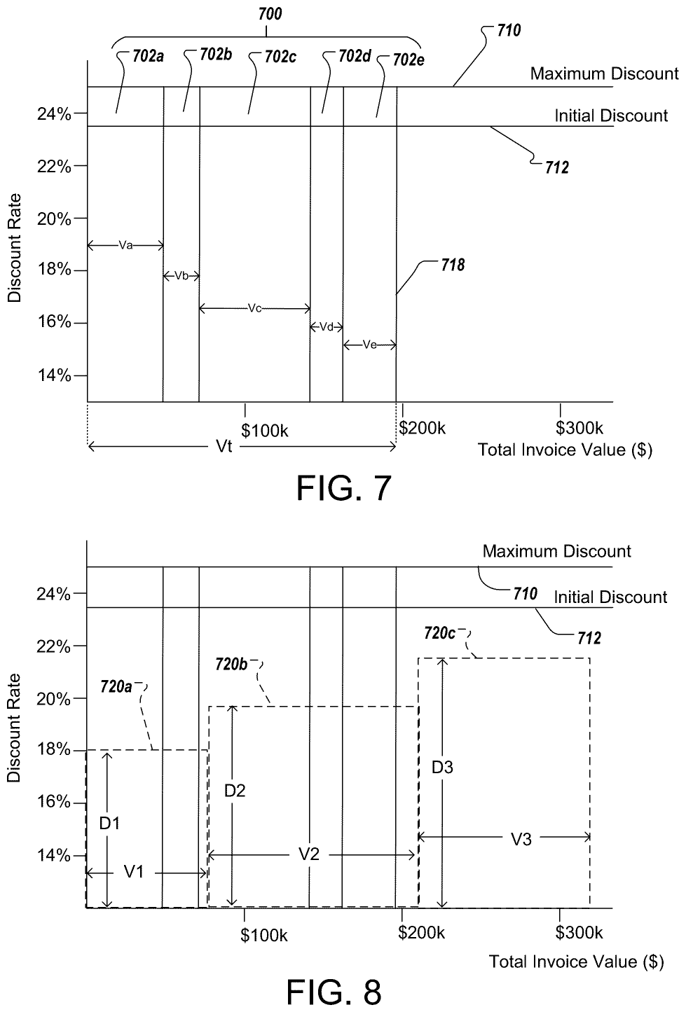

Turning to FIG. 4A, the auction server system 102 causes the display 104a to display a table 300a with each row 302 in the table 300 includes an entry for the customer 310 (identified as the “Buyer”). In addition, the two-axis score 320a is displayed in proximity, e.g., immediately following, the entry for the customer. Here the two-axis score 320a is displayed simply as an two-character alphanumeric code. However, the score 320a could instead be displayed as a single-character overall risk level code score.

Turning to FIG. 4B, in another implementation which is similar to FIG. 4A, rather than a two-character alphanumeric code, the two-axis score 320b is displayed graphically in the table 300b. In particular, the row 302 can include a matrix 322 with a number of rows 324 equal to the number of possible values for one axis of the score, e.g., the “financial score,” and a number of columns 326 equal to the number possible values for the other axis of the two scores, e.g., the “guarantor score.” So in the example of four values each (A through D and 1 through 4), a 4×4 matrix 322 is shown. In the example illustrated, the safest score is in the upper right corner and the riskiest score is in the lower left, but other orientations are possible. An indicia 328 is displayed in the cell corresponding to the two-axis score in order to graphically display the score. The matrix 322 corresponding to the can be color coded, e.g., green for lower risk combinations of the two-axis score, yellow, orange or red for increasingly higher risk combinations.

Presenting the information in this way allows a bidder to quickly understand both shorter term financial risk as well as the eventual likelihood of collection if default occurs, thereby allowing the bidders to better set an appropriate discount rate to offer for the invoice.

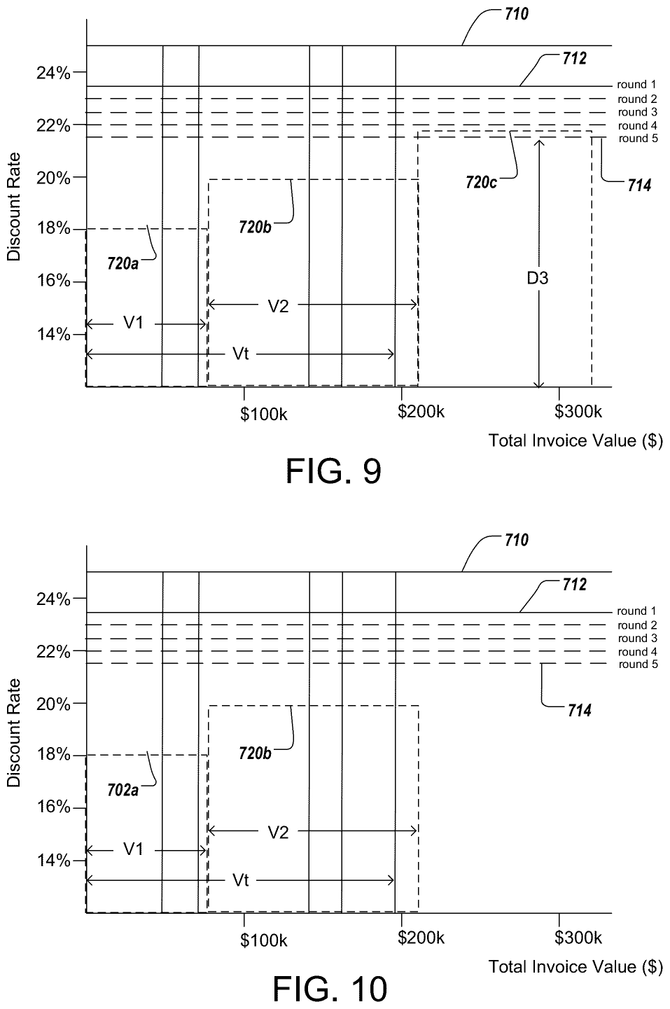

FIG. 5 illustrates a user interface 500 to be displayed on a display of the bidder, e.g., as dialog box or the like. The user interface 500 permits the bidder to adjust the default values, e.g., the values in Table 4, used to calculate risk level score. The user interface 500 can be accessible from a user settings screen. In some implementations, the user interface 500 is displayed automatically when a bidder creates an account. The display of the user interface 500 can be implemented by HTML, etc.

In the implementation of FIG. 5, the user interface 500 includes multiple rows 510, with each row corresponding to one of the possible risk level scores, excepting the lowest risk level score. Thus there is one fewer row than the number of possible risk level scores. So in the example of FIG. 5, with risk level scores “A”, “B”, “C”, “D”, and “F”, there are four rows 510.

Each row 510 includes text 512 showing the risk level score, and a user interface element 514 which permits the bidder to select a value for the minimum confidence level for that risk level score. The user interface element 514 could be a drop-down menu, slider, or a textbox, for example. Selection or input of the confidence level into the user interface element 514 updates the range of values used to calculate the risk level score, e.g., adjusts the values in Table 4. Thus, when the graph 410 (see FIG. 3C) is displayed, the appropriate separation line(s) 415 will have an adjusted position. Note however, the position of the indicia 430 within the graph 410 would not necessarily change; simply what risk level score is associated with that position.

Each stored risk curve can have a unique identifier and optionally one or more tags that may be used later by the bidder, e.g., for the bidder to search for risk curves that match a desired tag. For example, a bidder can search for stored risk curves for bids on tangible products (as opposed to services) by searching for an appropriate “tangible” tag.

In some implementations, the term period of the invoice can also be considered as part of the risk level score. In this case, the risk level score would be on an invoice-by-invoice basis for a customer. For this purpose, each row 510 can include a user interface element 520, e.g., a drop-down menu or a textbox, that permits entry of a maximum term for that risk level. An invoice or a lot of invoices is assigned the highest risk level score for which both the confidence level and maximum term are met. For example, in the settings shown in FIG. 5, in order to be assigned score of “A”, the customer would need to be assigned confidence level of at least 0.95, and the invoice would need to be no more than 180 days.

As noted above, a bidder may not wish to engage in all auctions. Thus, the user interface 500 can also be used to automatically select invoices for review, e.g., select when the bidder is to be informed of an invoice. For example, a bidder can set a preference such that invoices that receive the lowest risk level score, e.g., “F”, are not displayed or forwarded to the bidder. Other criteria that can be used to select invoices include the identity of the customer, the industry, the invoice amount, the geographic location of the customer, the invoice term, etc.

In addition, invoice auctions in which the smallest invoice exceeds the value that the bidder is willing to invest can be automatically screened, i.e., not displayed or forward to the bidder. For this purpose, each row 510 can include a user interface element 530, e.g., a drop-down menu, slider, or a textbox, that permits entry of a maximum amount for an invoice that a bidder is willing to bid on. For an auction in which each invoice exceeds the maximum amount, the bidder need not be informed of the auction. This amount can be different for each score.

The user interface 500 can also be used to either to automatically set (or automatically provide a recommendation), for the minimum acceptable discount for an invoice in an auction. For this purpose, each row 510 can include a user interface element 540, e.g., a drop-down menu or a textbox, that permits entry of a minimum discount for an invoice of the associated risk level score.

In some implementations, a bidder may be comfortable with certain customers and be willing to bid regardless of the associated risk level score. Thus, the user interface 500 can also include a user interface element 550, e.g., a radio button, that permits the risk level setting to be overridden for specific customers, and one or more user interface elements 555, e.g., drop-down menus or textboxes, that permit entry of the name of customer.

In addition to providing information for a “manual” bidding, the user interface 500 can be used to automate the participation by the bidder, e.g., by selecting invoices or invoice lots to bid on, and by submitting the terms of the bid.

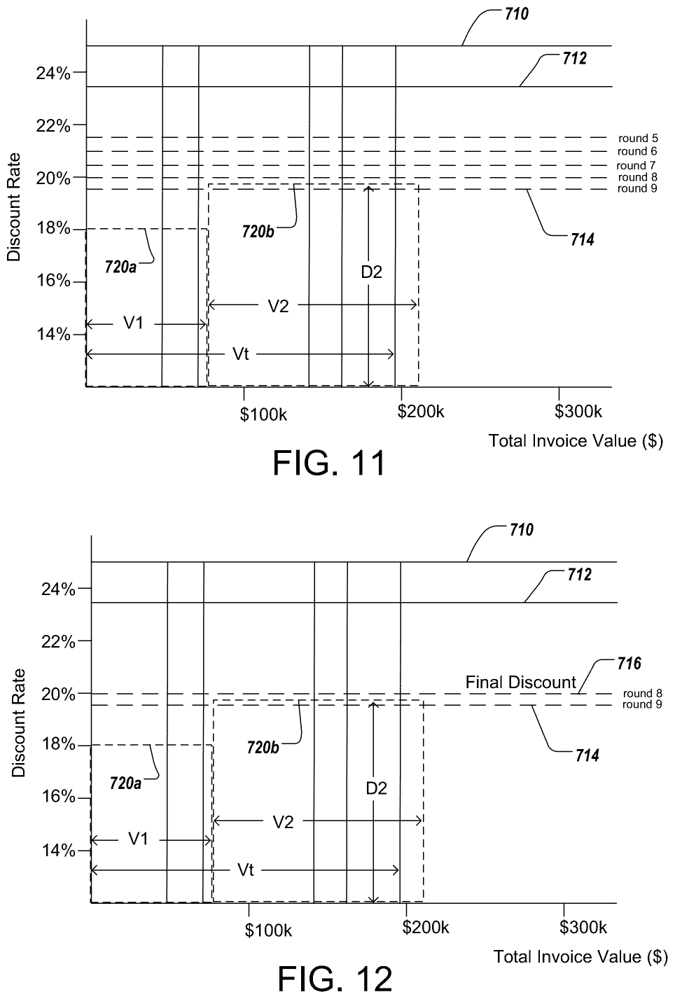

A flowchart of a process 600 that can use either manual or “automated” bids (i.e., in a computer-based programmatic manner without user intervention) from the bidders is shown in FIG. 6. As noted above, the auction server system 102 receives data indicating authorization for auctioning of one or more invoices (see step 202 in FIG. 6). Where there are multiple invoices, the invoices can be provided as a “lot”. In the case of traditional factoring, the auction authorization can be received from a supplier computer system 106. In the case of reverse factoring, the auction authorization can be received from a buyer computer system 108.

The supplier also indicates, e.g., through the supplier computer system 106 to the auction server system 102, a maximum acceptable discount rate.

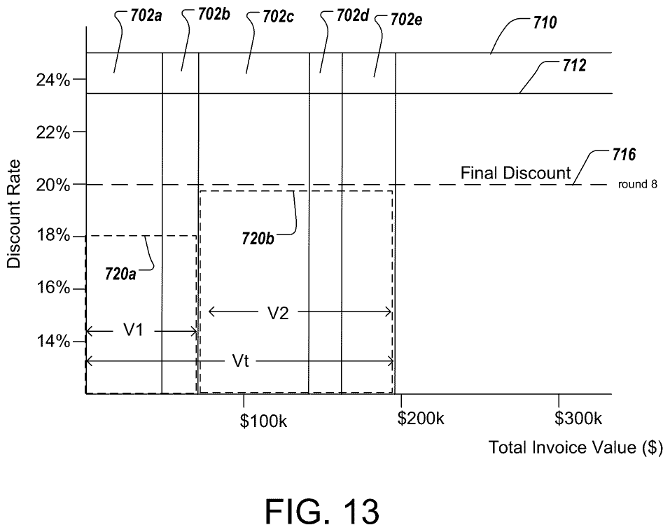

An example of the initial situation is illustrated in FIG. 7, which schematically shows a lot 700 of five invoices 702a-702e. Each individual invoice 702a-702e has an amount due (or value) Va-Ve, illustrated by the width of the respective column, with the lot 700 of invoices having a total value Vt at line 718. In this example, there are five invoices ranging in value from about $20 k to about $90 k, with a total value for the lot of just under $200 k. However, this is simply illustrative: there could be a different number of invoices, different sets of values for the invoices, etc.

The maximum discount 710 acceptable to the supplier is shown by a horizontal line. In this example, the supplier has selected a maximum discount of 25%, but again, this is simply illustrative.

The auction server system 102 can calculate a “initial discount rate” 712. This will be the discount rate at which the auction server system starts, as discussed below. The difference between the supplier's maximum discount rate and the initial discount rate covers the commission for the auctioneer. In this example, the auctioneer has a 1.5% commission, so the initial discount rate is 23.5%, but again, this is simply illustrative.

A variety of techniques are possible for the bidder to participate in the auction. For example, a user 104b of the bidder computer system 104 can use a general-purpose web-browser program, e.g., Internet Explorer or Chrome, to access a web-browser accessible website provided by the auction server system 102. As another example, the user 104b of the bidder computer system 104 can run a dedicated application that is provided by the auction provider and configured for secure communication with the auction server system 102.

For the auction, the auction server system 102 sends a message out to each bidder computer system 104 that has indicated interest in receiving auctioned invoices (see step 604 in FIG. 6). The message includes the pertinent information for the lot, e.g., the amount, term, identity of supplier, and identity of customer for each invoice in the lot. In general, in a lot with multiple invoices, each invoice will have the same: i) payment date, ii) buyer and iii) currency. This prevents mixed payment dates and mixed buyers in the same auction, so that the risk is uniform across the invoices in the lot. The message can also include a starting time for the auction. Typically the bids are solicited at least 24 hours before the auction begins.

The bidders 104b may select to review, or instruct the auction server system 102 to send, only certain invoices. For example, the auction server system 102 can implement a filter system that permits a bidder 104b to receive invoices within a certain size range, of type of good or service, within a certain term, etc. In particular, the user interface 500 discussed above can define which auctions are presented to the bidder.

For each bidder that chooses to participate, the bidder submits a bid to the auction server system (see step 606 in FIG. 6). The bid includes a minimum discount rate and a maximum amount that the bidder is willing to cover. Optionally the bid could include a minimum amount that the bidder is willing to cover.

For a “manual” bid, the bidder can enter the minimum discount rate and the maximum amount that the bidder is willing to cover into the bidder computer system 104, e.g., using a graphical user interface. That minimum discount rate and maximum amount is forwarded by the bidder computer system 104 to the auction server system 102, e.g., by email, by interaction through a web page, etc.

For the “automated” bidding process, an automated process is run either by the bidder computer system 104 or by the auction server system 102 itself. In brief, the automated process uses the settings previously entered by bidder using the user interface 500. For example, the bidder may have entered settings before supplier or buyer even submitted the invoices for auction.

In particular, the automated process identifies the risk level score for the auction. The invoice or lot of invoices is assigned the highest risk level score for which both the confidence level and maximum term are met. The automated process then identifies the corresponding maximum amount 530 and minimum discount 540 for that financial rating.

Where the automated process is run by the bidder computer system 104, the minimum discount rate and maximum amount is forwarded to the auction server system 102. Where the automated process is run by the auction server system 102, such communication can be dispensed with. However, the auction server system 102 could still send a message to the bidder computer system 104 indicating that a bid will be submitted on behalf of the bidder, and providing an option to opt out of the auction.

Once the designated starting time arrives, the auction 610 can begin.

The auction server system 102 can compare and prioritize the bids received from lowest minimum discount rate to the highest minimum discount rate (see step 612 in FIG. 6). An example of the situation after sorting is illustrated in FIG. 8, which schematically shows three bids 720a-720c from three bidders. Each individual bid 720a-720e has a maximum amount covered V1-V3, illustrated by the width of the respective box, and a minimum discount rate D1-D3, illustrated by the height of the respective box. In this example, there are three bidders, with the lowest bid at 18%, the second lowest at 19.8%, and the highest at 21.8%. Again, this is simply illustrative: there could be a different number of bidders, different minimum discount rates and maximum amounts covered.

Returning to FIG. 6, an “acceptable minimum discount rate” is set equal to the initial discount rate (step 614). The auction server system 102 then begins a series of auction rounds (620). At each round, starting at the initial discount, the auction server system determines whether one of the remaining bidders has a minimum discount rate that equal to or greater than the acceptable discount rate (622). If no such bidder exists, then the system reduces by acceptable discount rate by a bid increment (624) (the “bid increment” is the size of the step between bids, rather than indicating an increase in the acceptable discount rate). The system iterates these steps until such a bidder is found.

Once a bidder who has a minimum discount rate that is equal to or greater than the acceptable discount rate is found, the system determines whether total amount covered by the other bidders with lower minimum discount rates is sufficient to cover the total value Vt of the invoices (626).

If the other bidders do have a total amount covered that covers the total value Vt of the invoices, the bidder with the highest minimum discount rate is eliminated from the auction (628).

This is shown in FIGS. 9 and 10, where the acceptable discount rate 714 starts at the initial discount rate 712 at round 1. Then each subsequent round (rounds 2 through 5), the acceptable discount rate 714 is reduced by a set amount. The amount can be set by the auctioneer or the supplier, or can be calculated automatically by an algorithm in the auction server system. In the drawings the bid increment is shown as 0.5%, but in practice a larger or smaller amount can be used, e.g., anywhere from 0.0001% to 10%, e.g., 0.25%. In addition, rather than decrementing by a percentage, the bid increment could be a certain dollar value. Moreover, the bid increment could be calculated based on the granularity of the discount rates of the bids, the minimum and maximum allowable granularity that the auction permits, and the granularity that the supplier is willing to allow. At round 5, the third bid 720c has a minimum discount rate D3 which is lower than the current acceptable discount rate 714 for the round. However, the two remaining bids 720a, 720b, have a total amount covered (V1 plus V2) that is greater than the total value Vt of the invoices. Thus, the third bid 720c is eliminated.

Assuming a bidder is eliminated, the system reduces by acceptable discount rate by a bid increment (step 624) and the series of auction rounds is continued.

If the other bidders, i.e., bidders other than the bidder under consideration for removal as having the highest minimum discount rate, do not have a total amount covered that covers the total value Vt of the invoices, then the bidder under consideration for removal is not removed, and the auction rounds are completed, with the remaining bids being considered as winning bids based on a criteria set by default, the auction administrator or based on certain criteria as selected by the seller. This is shown in FIG. 11, where at round 9 the acceptable discount rate 714 falls below the minimum discount rate D2 of the second bid 720b. However, if bid 720b were to be eliminated, then the total value (V1) of the remaining bid 720a would not cover the total value Vt of the invoices. Thus the first bid 720a and second bid 720b can be considered winning bids.

Next, the auction server system 102 determines a final discount rate (which can be referred to as a “pay-as-clear” discount rate) for the winning bids (632). In particular, the auction server system 102 finds the acceptable discount rate for the round immediately prior to the final round. This is equal to or greater than the minimum discount for the highest of the remaining bids. This is shown in FIG. 12, where the final discount 716 is set as the acceptable discount rate at round 8. All winning bids will receive this final discount rate. Thus, the bid with the lowest minimum discount rate actually receives a final discount significantly higher than its bid, e.g., 20% as opposed to 18%.

The auction server system 102 also allocates the invoices between the winning bids (634). This step could be switched with the determination of the discount rate. No individual invoice in the lot 700 may have a value equal to the maximum amount covered by any bid. Moreover, combinations of invoice in the lot 700 may still not have a total value equal to the maximum amount covered by any bid.

To allocate the winning bids, the auction server system 102 uses a knapsack auction algorithm. In particular, starting with the bid having the lowest discount rate, the auction server system 102 finds the combination of invoices that will be closest to, without exceeding, the maximum amount covered by that bid. This process iterates, each time allocating invoices to the bid next lowest discount rate, until all invoices are allocated. In some implementations, individual invoices are not “broken up” into partial values as this can result in complicated legal situation for collection in some jurisdictions. However, other implementations, individual invoices can be “broken up” into partial values. In any event, as a result, each bid is typically reduced, i.e., to the amount equal to the total value of the allocated invoices.

This is shown in FIG. 13, two invoices 702a and 702b are allocated to the first bid 720a, and three invoices 702c, 702d, 702e are allocated to the second bid 720b. As a result, the first bid 720a wins invoices totaling an amount (Va+Vb) that is as close to the maximum amount V1 as possible, given the possible combinations of invoices and without exceeding the maximum amount V1. The second bid 720b wins invoices totaling an amount (Vc+Vd+Ve), which is as close to the maximum amount V2 as possible, given the possible combinations of remaining invoices (i.e., excluding invoices already allocated) and without exceeding the maximum amount V2. As a result, the winning bid having the lowest minimum discount rate is most likely to receive closest to their maximum amount covered. The winning bid having the highest minimum discount rate could receive only a small portion of maximum amount covered.

In some situations, the knapsack algorithm may be initially unable to allocate all of the invoices. In this case, a new loop can be started, in which the acceptable minimum discount rate is incremented (rather than decremented) with each pass through the loop. After each increment, some bids (that have a minimum discount rate that falls within the new increased acceptable discount rate) can be added as winning bids. The knapsack algorithm is executed again, e.g., after each loop or each time a bid is added as a winning bid. If the knapsack algorithm is still unable to allocate the invoices, the loop is performed again. Once the knapsack algorithm is successful, the loop is exited.

At this point the auction is complete, and the auction server system 102 can send a report of the auction results to the participants. In particular, the auction server system 102 informs, e.g., by email, the bidder computer system of each winning bidder the amount that the winning bidder has to pay to the auctioneer. Winning bidders can have a set time, for example a 24 hour period to transfer the funds, in the meantime the auction server system 102 can send the promissory notes to the customer or supplier computer system if applicable. When the auctioneer receives the funds transfers them to the supplier, retaining its commission. A number of days before the payment date before the payment date, the auction server system 102 sends a reminder to the computer system of the responsible party that payment is due. The number of days can be preset, e.g. from one to seven days, or calculated by the auction server system based on the size of the invoice, credit rating of the customer, etc. Presumably the responsible party pays the auctioneer, and the auctioneer transfers the funds to the bidder.

The result is that the supplier gets the cash for invoices submitted better than any loosing bid (at or just above the lowest discount rate of the highest winning bid), and the winning bidders receive discount rates equal to or higher than their minimum discount rate.

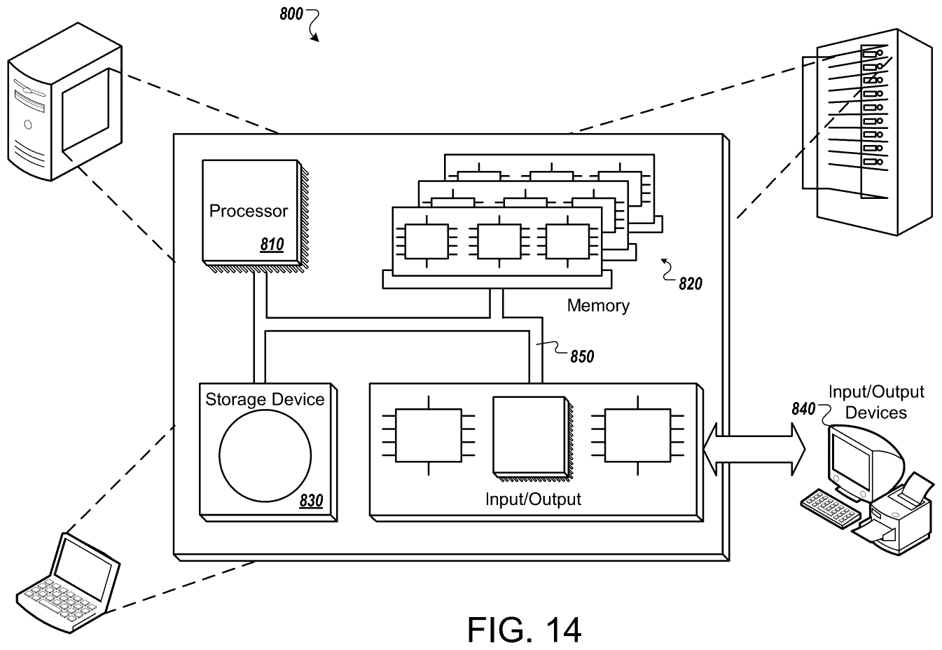

FIG. 14 is a schematic diagram of an example of a generic computer system 800. The system 800 can be used for any of the operations described above. For example, the system 800 may provide any or all of the auction provider server system 102, the bidder computer system 104, the supplier computer system 106, or the customer computer system 108.

The system 800 includes a processor 810, a memory 820, a storage device 830, and an input/output device 840. Instructions that implement operations associated with the methods described above can be stored in the memory 820 or on the storage device 830. Each of the components 810, 820, 830, and 840 are interconnected using a system bus 850. The processor 810 is capable of processing instructions for execution within the system 860. In some implementations, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. In some implementations, the memory 820 is a non-volatile memory unit.

The storage device 830 is capable of providing mass storage for the system 800. In some implementations, the storage device 830 is a computer-readable medium. In various different implementations, the storage device 830 may be a floppy disk device, a hard disk device, an optical disk device, or a tape device.

The input/output device 840 provides input/output operations for the system 800. In some implementations, the input/output device 840 includes a keyboard and/or pointing device. In another implementation, the input/output device 840 includes a display unit for displaying graphical user interfaces.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions encoded on a computer storage medium for execution by, or to control the operation of, data processing apparatus. The computer storage medium can be a machine-readable storage device, a machine-readable storage substrate, a random or serial access memory device, or a combination of one or more of them. Alternatively or in addition to being encoded on a storage medium, the program instructions can be encoded on a propagated signal that is an artificially generated signal, e.g., a machine-generated electrical, optical, or electromagnetic signal, that is generated to encode information for transmission to suitable receiver apparatus for execution by a data processing apparatus.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. One or more non-transitory computer-readable media storing instructions that, when executed by one or more computers of an invoice auction processing computer system, cause the one or more computers to:
maintain at least one data store defining a respective account for a customer and/or a supplier, and for each of a plurality of bidders;
receive a request to submit an invoice for auction, wherein one of the customer or supplier is a responsible party;
collect and store as data an identity of the supplier for the invoice, an identity of the customer for the invoice, an amount of the invoice, and a payment due date for the invoice;
generate a first score that represents a likelihood that the responsible party will default on an auctioned invoice and a second score that represents a likelihood of collection from the responsible party on a defaulted auctioned invoice;
for each respective bidder of one or more bidders from the plurality of bidders, cause a display of a bidder computer system of the respective bidder to display a graph having a first axis corresponding to the likelihood that the responsible party will default on an auctioned invoice and a second axis corresponding to the likelihood of collection from the responsible party on a defaulted auctioned invoice, and display an indicia at a location in the graph correspond to the first score and the second score; and
receive from at least one bidder of the one or more bidders a bid for the invoice.

2. The computer-readable media of claim 1, comprising instructions to receive an indication of whether the auction is a traditional auction or a reverse auction, to designate the customer as the responsible party if the auction is indicated as a traditional auction, and to designate the suppliers as the responsible party if the auction is indicated as a reverse auction.

3. The computer-readable media of claim 1, comprising instructions to calculate an overall risk level score from the first score and the second score, and to display the overall risk level score on the display of the bidder computer system.

4. The computer-readable media of claim 3, comprising instructions to calculate the overall risk level score comprise instructions to calculate an overall risk level value from the first score and the second score.

5. The computer-readable media of claim 4, wherein the instructions to calculate the overall risk level value comprise instructions to calculate a weighted average of the first score and the second score.

6. The computer-readable media of claim 4, wherein the instructions to calculate the overall risk level value comprise instructions to calculate a geometric mean of the first score and the second score.

7. The computer readable media of claim 4, comprising instructions to compare the overall risk level value to a plurality of thresholds, each threshold having an associated score, wherein a highest score for which the risk level value exceeds the associate threshold value is assigned as the risk level score.

8. The computer-readable media of claim 7, comprising instructions to display a user interface to the bidder and receive user input setting the plurality of thresholds through the user interface.

9. The computer-readable media of claim 8, wherein the instructions to display the user interface comprise instructions to display a plurality of rows with each row having a score and an interface element to set the associated threshold value for the score.

10. The computer-readable media of claim 1, comprising instructions to calculate the first score with a logistic regression model.

11. The computer-readable media of claim 1, comprising instructions to calculate the first score with a weighted average.

12. One or more non-transitory computer-readable media storing instructions that, when executed by one or more computers of an invoice auction processing computer system, cause the one or more computers to:
maintain at least one data store defining a respective account for a customer and/or a supplier, and for each of a plurality of bidders;
receive a request to submit an invoice for auction;
collect and store as data an identity of the supplier for the invoice, an identity of the customer for the invoice, an amount of the invoice, and a payment due date for the invoice;
generate a first score that represents a likelihood that the customer will fulfill payment on an auctioned invoice and a second score that represents a likelihood that the supplier will fulfill payment on the auctioned invoice;
for each respective bidder of one or more bidders from the plurality of bidders, cause a display of a bidder computer system of the respective bidder to display a graph having a first axis corresponding to the likelihood that the customer will fulfil payment on the auctioned invoice and a second axis corresponding to the likelihood that the supplier will fulfil payment on the auctioned invoice, and display an indicia at a location in the graph correspond to the first score and the second score; and
receive from at least one bidder of the one or more bidders a bid for the invoice.

13. One or more non-transitory computer-readable media storing instructions that, when executed by one or more computers of an invoice auction processing computer system, cause the one or more computers to:
maintain at least one data store defining a respective account for a customer and/or a supplier, and for each of a plurality of bidders;
receive a request to submit an invoice for auction;
collect and store as data an identity of the supplier for the invoice, an identity of the customer for the invoice, an amount of the invoice, and a payment due date for the invoice;
generate a first score that represents a likelihood that the supplier will default on an auctioned invoice, a second score that represents a likelihood of collection from the supplier on a defaulted auctioned invoice, and a third score that represents a financial strength of the customer;
generate a combined risk level score from a calculated combination of the first score, the second score, and the third score;
for each respective bidder of one or more bidders from the plurality of bidders, cause a display of a bidder computer system of the respective bidder to display the combined risk level score; and
receive from at least one bidder of the one or more bidders a bid for the invoice.

14. The computer-readable media of claim 13, wherein the calculated combination provides a risk level value.

15. The computer-readable media of claim 14, wherein the calculated combination comprises a weighted average of the first score, second score, and third score.

16. The computer-readable media of claim 15, comprising instructions to receive an indication of a mode of payment, and wherein weights in the weighted average depend on the mode of payment.

17. The computer readable media of claim 14, comprising instructions to compare the risk level value to a plurality of thresholds, each threshold having an associated score, wherein a highest score for which the risk level value exceeds the associate threshold value is assigned as the combined risk level score.

18. One or more non-transitory computer-readable media storing instructions that, when executed by one or more computers of an invoice auction processing computer system, cause the one or more computers to:
maintain at least one data store defining a respective account for a customer and/or a supplier, and for each of a plurality of bidders;
for each respective bidder of one or more bidders from the plurality of bidders, cause a display of a bidder computer system of the respective bidder to display a user interface, the user interface including a plurality of scores and a plurality of interface elements to set a plurality of thresholds values with each respective interface element setting a threshold value for an associated score;
receive a request to submit an invoice for auction;
collect and store as data an identity of a supplier for the invoice, an identity of a customer for the invoice, an amount of the invoice, and a payment due date for the invoice;
generate a risk level value representing a risk of failure to collect on the invoice;
compare the risk level value to the plurality of thresholds, wherein a highest score for which the risk level value exceeds the associate threshold value is assigned as a combined risk level score;
for each respective bidder of one or more bidders from the plurality of bidders, cause a display of a bidder computer system of the respective bidder to display the combined risk level score; and
receive from at least one bidder of the one or more bidders a bid for the invoice.

19. One or more non-transitory computer-readable media storing instructions that, when executed by one or more computers of an invoice auction processing computer system, cause the one or more computers to:
maintain at least one data store defining a respective account for a customer and/or a supplier, and for each of a plurality of bidders;
receive a request to submit a transaction for auction, wherein one of the customer or supplier is a responsible party;
collect and store as data an identity of the supplier for the transaction, an identity of the customer for the transaction, a bidding variable for the transaction, and a due date for the transaction;
generate a first score that represents a likelihood that the responsible party will default on the transaction and a second score that represents a likelihood of enforcement on a defaulted transaction;
for each respective bidder of one or more bidders from the plurality of bidders, cause a display of a bidder computer system of the respective bidder to display a graph having a first axis corresponding to the likelihood that the responsible party will default on the transaction and a second axis corresponding to the likelihood of enforcement of a defaulted transaction, and display an indicia at a location in the graph correspond to the first score and the second score; and
receive from at least one bidder of the one or more bidders a bid for the transaction.
